(19) United States
(12) Patent Application Publication
(10) Pub. No.: US 2009/0013582 A1
(43) Pub. Date: Jan. 15, 2009

(54) METHOD AND APPARATUS FOR LIFTING FISH

(76) Inventors: Kokyou YOUNG, Houston, TX (US); Jeanette M. L. Young, Houston, TX (US)

Correspondence Address: CLARENCE E. ERIKSEN & ASSOCIATES, P.C., NINE GREENWAY PLAZA, SUITE 3100, HOUSTON, TX, 77046-0904, US

(21) Appl. No.: 11/774,850

(22) Filed: Jul. 9, 2007

(51) Int. Cl. A01K 97/14; A01K 97/00

(52) U.S. Cl. 43/5

(57) ABSTRACT

A fish lifting device is disclosed for use with fishing pole apparatus comprising a fishing line having a high-test leader at its distal end. The fish lifting device comprises a plate having first and second ends and at least two side portions. A first opening is formed in the plate proximate its first end, and a second opening is formed in the plate between the first opening and the second end of the plate. A first elongated channel is formed in the plate and extends from the second opening toward the second end of the plate, and a second elongated channel is formed in the plate between one of the sides and the second opening. A fish lifting device according to the present invention may further comprise a utility line which is operatively secured to the plate by engaging the first opening.

### BACKGROUND OF THE INVENTION

1. Field of the Invention

The present invention relates method or methods for lifting fish from a first elevation to a second elevation.

2. Description of the Prior Art

It is quite common for fisherman to fish from an elevated perch, such as a pier, bridge, platform or dock. The Gulf Coast area, for example, has a number of fishing piers which extend from land out into the ocean. When fishing under such conditions, the fisherman is required to lift the hooked fish from a first elevation, i.e. the ocean, to a second higher elevation i.e. the pier, without losing the fish.

Various methods have been utilized in an attempt to get the fish to the higher elevation without losing it. For example, the fisherman may try just reeling in the fish. However, a fish is prone to wiggle off the hook during such reeling activity. Also, a larger fish that is being reeled in may exceed the weight limit of the fishing line which results in the line breaking and the fish being lost. Another method which has been utilized is a net which is on a long handle. This approach is unwieldy due to the height separation which exists between the fisherman and the fish. Also, larger fish may be capable of jumping out of the net.

Yet a further approach which has been utilized is using a “hoop net.” A hoop net is a circular net attached to a hoop and secured to a rope. The hoop net is positioned beneath the hooked fish and then hauled upwards by the rope. A hoop net is frequently awkward to guide, especially in windy conditions, and the hoop net can be too shallow for a large fish.

### SUMMARY OF THE INVENTION

In accordance with the present invention, a fish lifting device is provided for use with fishing pole apparatus comprising a fishing line having a high-test leader at its distal end. A fish lifting device according to the present invention comprises a plate having first and second ends and at least two side portions. A first opening is formed in the plate proximate its first end, and a second opening is formed in the plate between the first opening and the second end of the plate. A first elongated channel, which is formed in the plate, extends from the second opening toward the second end of the plate. A second elongated channel is formed in the plate between one of its sides and the second opening.

A fish lifting device in accordance with the present invention may further comprise a utility line which is operatively secured to the plate by engaging the first opening. In one embodiment, the utility line comprises a rope which is attached to a swivel eye spring hook which engages the first opening in the plate. In yet another embodiment, the utility line comprises a rope which is secured to the plate through first opening.

The shape of the plate in a fish lifting device in accordance with the present invention may have an arbitrary shape, and, in one embodiment, the plate is rectangular in shape. In yet another embodiment, a fish lifting device according to the present invention is generally fish-shaped. The material from which the plate is fabricated may, for example, be metal, although other materials such as hard plastic and carbon fiber material may be used. In one embodiment, the plate is fabricated from aluminum.

In accordance with the present invention, a method is provided for lifting a fish from a first elevation to a second elevation, where the fish has been hooked by a fisherman located at the second elevation using a fishing pole comprising a fishing line having a connector, e.g., a swivel, and a high-test leader section at its distal end. A method according to the present invention comprises the step of passing the fishing line that is proximate the fisherman through a first channel formed in a plate and into an opening which is also formed in that plate which is in communication with the first channel. The plate may then be lowered toward the distal end of the fishing line with a utility line secured to the plate. The plate is lowered until it is below the connector. The next step in a method according to the present invention is securing the high-test leader portion of the fishing line in a second channel in the plate. This second channel is in communication with the opening in the plate, and the securing of the high-test leader portion may be effected by applying an upward force to the utility line. Once the high-test leader portion of the fishing line is secured, the hooked fish may be lifted by continuing to apply an upward force to the utility line.

### BRIEF DESCRIPTION OF THE DRAWINGS

In the accompanying drawings, FIG. 1 is a perspective view of one embodiment of a fish lifting device in accordance with the present invention.

FIG. 2 is a top view of another embodiment of a fish lifting device in accordance with the present invention.

FIGS. 2a and 2b are perspective views of end portions 30 and 31, respectively, of the fish lifting apparatus of FIG. 2.

FIG. 3 is an elevation view of a swivel eye spring hook which is utilized in a utility line in one embodiment of the present invention.

FIGS. 4a and 4b are pictorial drawings illustrating certain aspects of a method in accordance with the present invention.

FIG. 5 is a perspective view of a fish lifting device being locked into place on the high-test leader of a fishing line.

### DESCRIPTION OF THE SPECIFIC EMBODIMENTS

It will be appreciated that the present invention may take many forms and embodiments. In the following description, some embodiments of the invention are described and numerous details are set forth to provide an understanding of the present invention. Those skilled in the art will appreciate, however, that the present invention may be practiced without those details and that numerous variations and modifications from the described embodiments may be possible. The following description is thus intended to illustrate and not to limit the present invention.

With reference first to FIG. 1, one embodiment of fish lifting device 10 in accordance with the present invention comprises plate 11, which may, for example, be rectangular in shape. Plate 11 comprises two ends 12 and 13 and two side portions 14 and 15. Still referring to FIG. 1, a first opening 16 is formed in plate 11 proximate end 12, and a second opening 17 is formed in plate 11 between the first opening 16 and the second end 13 of plate 11. In one embodiment, the opening 17 is larger than the opening 16 and may, for example, be tear-drop shaped.

A first elongated channel 18 is formed in plate 11 and extends from the second opening 17 toward the second end 13 of plate 11. End 18a of channel 18, may, for example, have a circular cross-section. A second elongated channel 19 is formed in the plate 11 between one of its sides 15 and the second opening 17.

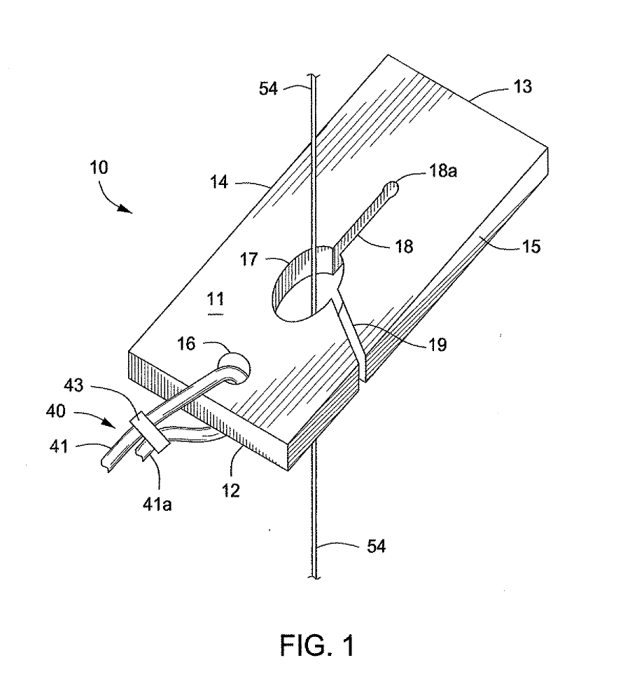

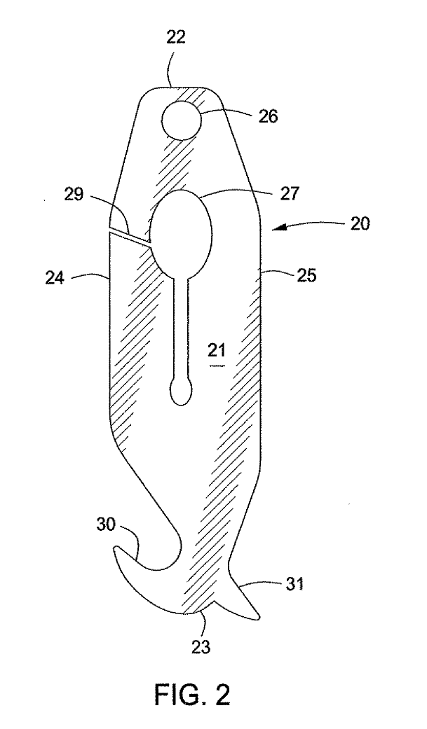

With reference now to FIG. 2, another embodiment of a fish lifting device in accordance with the present invention is illustrated. In this embodiment, fish lifting device 20 has the general shape of a fish. Fish lifting device 20 also comprises plate 21 in which are formed first and second openings 26 and 27 and first and second elongated channels 28 and 29. Openings 26 and 27 in FIG. 2 correspond to the openings 16 and 17, respectively, in FIG. 1, and elongated channels 28 and 29 correspond to elongated channels 18 and 19, respectively, in FIG. 1.

With reference to FIGS. 2a and 2b, the end portions 30 and 31, respectively, of fish lifting device 20 may be fabricated in a manner to facilitate handling of a fish once it is landed. End portion 30 may, for example, be fabricated as shown in FIG. 2a to enable a fisherman to secure a fish by one of its gills, while end portion 31 may be fabricated in a fashion to facilitate removal of a hook from the fish.

Fish lifting devices 10 and 20 of FIGS. 1 and 2, respectively, may, for example, be fabricated from any suitable material such as metal, hard plastic or carbon fiber material. In one embodiment, fish lifting devices 10, 20 are fabricated from aluminum.

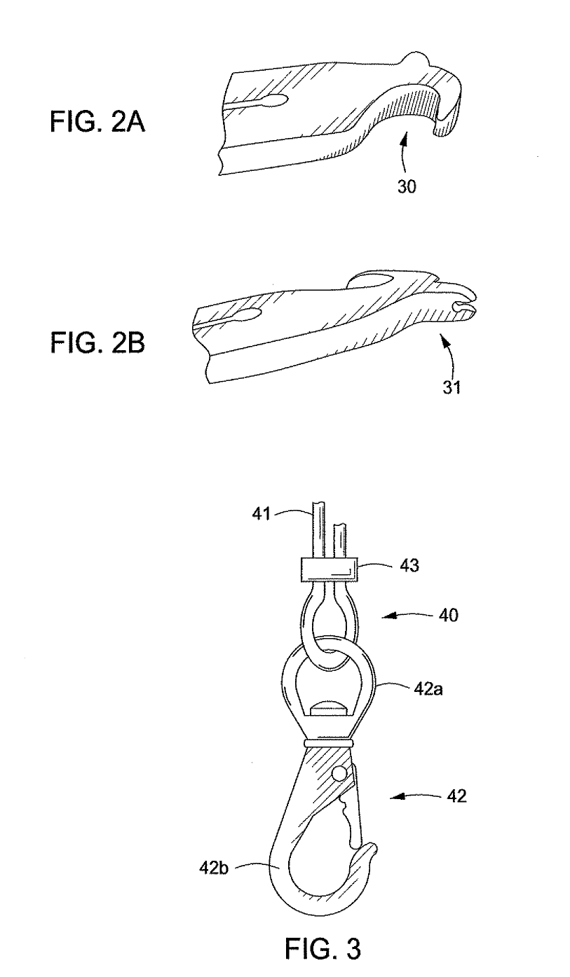

Referring to FIGS. 1, 2 and 3, a fish lifting device in accordance with the present invention may further comprise a utility line 40, including a rope 41. As illustrated in FIG. 1, one end of 41a may be inserted through first opening 16 and then be coupled to a rope 41 utilizing clamp 43. As illustrated in FIG. 3, one end 41a of rope 41 may be passed through eye 42a of swivel eye spring hook 42 and then coupled to rope 41 using clamp 43. The hook portion 42b of swivel eye spring hook 42 engages opening 16 in plate 11 (FIG. 1) or opening 26 in plate 21 (FIG. 2).

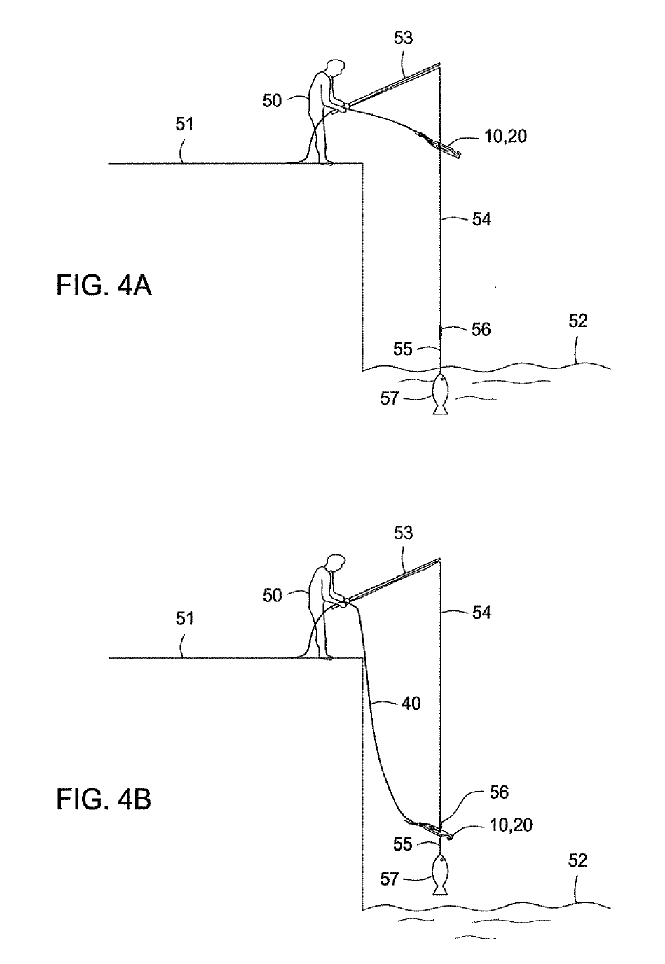

The operation of a fish lifting device according to the present invention is now discussed with respect to FIGS. 1, 2, 4a and 4b. In FIG. 4a, fisherman 50 is fishing at elevation 51 which is higher than the elevation of the water 52. Fisherman 50 is utilizing a fishing pole 53 comprising a fishing line 54 which includes a high-test leader portion 55 and a connector 56 at its distal end. The connector 56 may, for example, comprise a swivel. With reference to FIGS. 1 and 4a, when a fish 57 is hooked, the fisherman passes fishing line 54 through channel 19 and into opening 17 of fish lifting device 10. The fish lifting device 10 is then lowered utilizing utility line 40 until it is below connector 56, as illustrated in FIG. 4b.

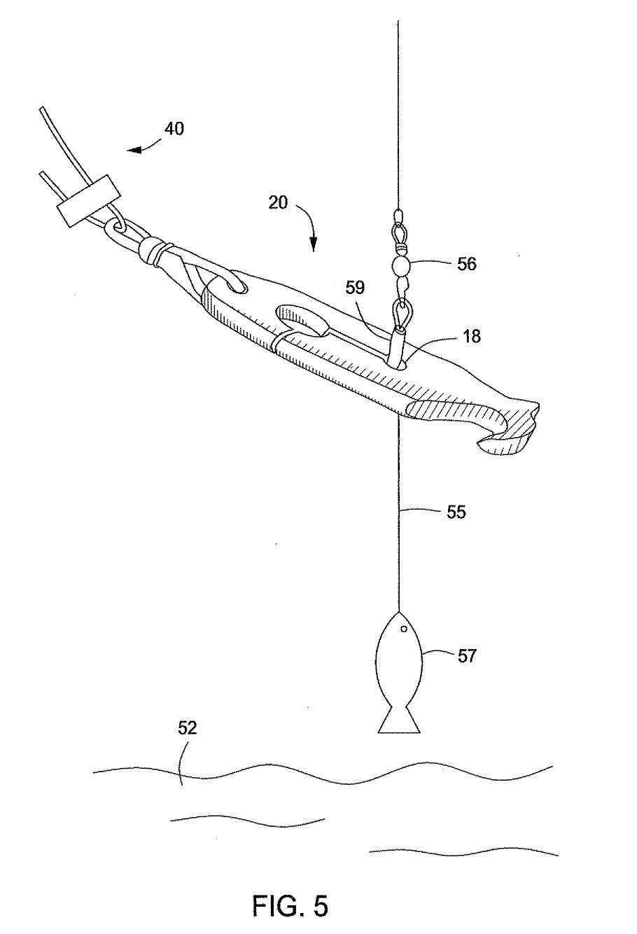

An upward force is then exerted on utility line 40 which causes the high test leader 55 to be pulled into channel 18, as illustrated in FIG. 5. This results in channel 18 engaging crimp connector 59 of the high test leader 55. Fish lifting device 10 is thus locked in place below connector 56, which is the strongest part of the tackle. Additional upward force may then be exerted on utility line 40 to raise fish 57 to elevation 51.

What is claimed is:

1. A fish lifting device for use with fishing pole apparatus comprising a fishing line having a high-test leader at its distal end, comprising:
a plate having first and second ends and at least two sides where: (a) a first opening is formed in the plate proximate its first end; (b) a second opening which is larger in diameter than the first opening is formed in the plate between the first opening and the second end of the plate; (c) a first elongated channel is formed in the plate and extends from the second opening toward the second end of the plate; and (d) a second elongated channel is formed in the plate between one of its sides and the second opening.

2. The fish lifting device of claim 1, further comprising a utility line which is operatively secured to the plate by engaging the first opening.

3. The fish lifting device of claim 2, wherein the utility line comprises a swivel eye spring hook which engages the first opening in the plate.

4. The fish lifting device of claim 1, wherein the plate is rectangular in shape.

5. The fish lifting device of claim 4, wherein the plate is fabricated from metal.

6. The fish lifting device of claim 5, wherein the plate is fabricated from aluminum.

7. The fish lifting device of claim 4, wherein the plate is fabricated from hard plastic.

8. The fish lifting device of claim 4, wherein the plate is fabricated from carbon fiber material.

9. The fish lifting device of claim 1, wherein the plate is generally fish-shaped.

10. The fish lifting device of claim 9, wherein the plate is fabricated from metal.

11. The fish lifting device of claim 10, wherein the plate is fabricated from aluminum.

12. The fish lifting device of claim 9, wherein the plate is fabricated from hard plastic.

13. The fish lifting device of claim 9, wherein the plate is fabricated from carbon fiber material.

14. A method of lifting a fish from a first elevation to a second elevation where said fish has been hooked by a fisherman located at said second elevation using a fishing pole comprising a fishing line having a connector and a high test leader section at its distal end, comprising:
a) passing the fishing line proximate the fisherman through a first channel formed in a plate and into an opening also formed in said plate which is in communication with said first channel;
b) lowering the plate toward the distal end of the fishing line with a utility line secured to the plate until the plate is below the connector;
c) securing the high test leader portion of the fishing line in a second channel in the plate which is in communication with the opening in the plate by applying an upward force to the utility line; and
d) lifting the hooked fish by continuing to apply an upward force to the utility line.
